(19) United States
(12) Patent Application Publication
(10) Pub. No.: US 2025/0000216 A1
(43) Pub. Date: Jan. 2, 2025

(54) SPRING BAR ASSEMBLY, WATCH STRAP, AND WATCH

(71) Applicant: Huawei Technologies Co., Ltd., Shenzhen (CN)

(72) Inventors: Shenglan Yuan, Dongguan (CN); Qian He, Xi’an (CN); Menglong Zhao, Xi’an (CN); Bin Zhang, Shenzhen (CN); Tianyu Cheng, Dongguan (CN); Junjie Yang, Dongguan (CN)

(21) Appl. No.: 18/885,955

(22) Filed: Sep. 16, 2024

Related U.S. Application Data
(63) Continuation of application No. PCT/CN2023/080517, filed on Mar. 9, 2023.

(30) Foreign Application Priority Data
Mar. 17, 2022 (CN) 202220587462.8
Nov. 29, 2022 (CN) 202223174241.7

(51) Int. Cl. A44C 5/14

(52) U.S. Cl. CPC A44C 5/14

(57) ABSTRACT

This application relates to a spring bar assembly, a watch strap, and a watch. The spring bar assembly includes a mounting base, a spring bar, a button, and a lever. Both the spring bar and the button are mounted on the mounting base. The button is capable of moving relative to the mounting base, and a movement direction of the button is perpendicular to an axial direction of the spring bar. One end of the lever extends into a guide groove of the button and abuts against first side walls of the guide groove, and the other end of the lever is connected to the spring bar. The button is capable of driving the spring bar to move relative to the mounting base in the axial direction of the spring bar by using the lever.

### CROSS-REFERENCE TO RELATED APPLICATIONS

This application is a continuation of International Application No. PCT/CN2023/080517, filed on Mar. 9, 2023, which claims priority to Chinese Patent Application No. 202220587462.8, filed on Mar. 17, 2022 and Chinese Patent Application No. 202223174241.7, filed on Nov. 29, 2022. All of the aforementioned patent applications are hereby incorporated by reference in their entireties.

### TECHNICAL FIELD

This application relates to the field of watch technologies, and in particular, to a spring bar assembly, a watch strap, and a watch.

### BACKGROUND

A spring bar assembly is a metal connecting piece used for connection between a watch face and a watch strap, and between a watch strap and a watch strap. The spring bar assembly includes a spring bar and a tube. The spring bar is configured to be connected to an adjacent watch strap or a watch face. When the watch strap needs to be replaced, a user needs to use a dedicated tool to adjust the spring bar, so that the spring bar moves toward the inside of the tube, to separate the adjacent watch straps, and the watch strap and the watch face. Without a dedicated tool, there is great difficulty in mounting and dismounting for the user, and the user usually needs to go to a maintenance shop for mounting and dismounting. This compromises user experience.

### SUMMARY

In view of the problem in the background, an objective of this application is to provide a spring bar assembly, a watch strap, and a watch. The spring bar assembly can reduce dismounting and mounting difficulty for a user.

A first aspect of this application provides a spring bar assembly. The spring bar assembly includes a mounting base, and a spring bar and a button that are mounted on the mounting base.

The mounting base includes a first accommodating cavity and a second accommodating cavity that are distributed in a radial direction of the spring bar. At least a part of the spring bar is located in the first accommodating cavity. At least a part of the button is located in the second accommodating cavity. The button is capable of moving relative to the mounting base. A movement direction of the button is perpendicular to an axial direction of the spring bar, and the movement direction of the button is perpendicular to a distribution direction of the first accommodating cavity and the second accommodating cavity. The button is provided with a guide groove.

The spring bar assembly further includes a lever. One end of the lever extends into the guide groove and abuts against first side walls of the guide groove, and the other end of the lever is connected to the spring bar.

The spring bar assembly further includes a first elastic piece. The first elastic piece is disposed in the mounting base, and the first elastic piece is connected to the spring bar or the lever.

When the button moves toward the spring bar, in the axial direction of the spring bar, the lever is capable of driving the spring bar to move toward the inside of the mounting base and compress the first elastic piece.

In the axial direction of the spring bar, the first elastic piece is capable of driving the lever and the spring bar to move toward the outside of the mounting base.

In this application, in a process of dismounting and mounting a watch strap and a watch face, a user presses the button to implement movement of the spring bar, so that the spring bar assembly switches between a locked state and an unlocked state. This simplifies an operation of dismounting and mounting the watch strap and the watch face by the user, reduces dismounting and mounting difficulty for the user, and improves user experience. The first elastic piece can be disposed to facilitate automatic reset of the spring bar and the lever and simplify the user operation.

In a possible design, in the axial direction of the spring bar tube, the spring bar includes at least a first spring bar and a second spring bar that are disposed opposite to each other.

The lever includes a first lever and a second lever. The first lever is connected to the first spring bar, and the second lever is connected to the second spring bar.

The button is capable of driving the first spring bar to move, and/or the button is capable of driving the second spring bar to move.

In this application, the button is capable of independently driving the first spring bar or the second spring bar to move, and the button is capable of simultaneously driving the first spring bar and the second spring bar to move, to improve diversity of unlocked states of the spring bar assembly.

In a possible design, one end of the first elastic piece abuts against the first spring bar, and the other end of the first elastic piece abuts against the second spring bar.

Alternatively, one end of the first elastic piece abuts against the first lever, and the other end of the first elastic piece abuts against the second lever.

In this application, the first elastic piece is connected to the spring bar or the lever. This improves flexibility of a mounting location of the first elastic piece.

In a possible design, the first elastic piece is clamped and fastened by the spring bar or the lever.

Alternatively, the spring bar or the lever is provided with a mounting portion, and the first elastic piece is tubed on the mounting portion.

In this application, the first elastic piece is directly clamped and fastened by the spring bar or the lever, so that structures of the spring bar and the lever are simplified. The first elastic piece is tubed on the mounting portion, so that stability of connection between the first elastic piece and the spring bar and connection between the first elastic piece and the lever is improved.

In a possible design, there is one spring bar and one lever.

In this application, there is one spring bar and one lever, so that a quantity of parts inside the mounting base is reduced, and a structure of the spring bar assembly is simplified, thereby reducing production costs of the spring bar assembly, and reducing an overall size of the spring bar assembly.

In a possible design, there is one or more first elastic pieces.

In this application, there is one or more first elastic pieces. This improves flexibility of a size and a type of the first elastic piece that may be selected.

In a possible design, the spring bar and the lever are disposed separately, the spring bar is provided with a fitting portion, and one end of the lever is fastened to the fitting portion.

Alternatively, the spring bar and the lever are integrally formed.

In this application, the spring bar and the lever are integrally formed, so that stability of connection between the spring bar and the lever can be improved, and working stability of the spring bar assembly is improved. The spring bar and the lever are disposed separately, so that the spring bar and the lever can be easily replaced, and an overall service life of the spring bar assembly can be extended. In addition, the spring bar assembly can be applicable to watch straps of different sizes, so that an application scope of the spring bar assembly can be expanded.

In a possible design, in the movement direction of the button, there is a preset included angle between an extension direction of the first side wall and the movement direction of the button.

In this application, the first side walls are disposed in an oblique manner, so that a structure of the guide groove is simplified, thereby reducing production costs of the button.

In a possible design, there is one guide groove, and the first side walls are disposed opposite to each other in the axial direction of the spring bar.

Alternatively, there are two guide grooves. The two guide grooves are distributed in the axial direction of the spring bar. In the axial direction of the spring bar, the guide groove includes second side walls that are disposed opposite to the first side walls. An extension direction of the second side wall is the same as the extension direction of the first side wall, or there is a preset included angle between an extension direction of the second side wall and the extension direction of the first side wall.

In this application, one guide groove is disposed, so that a structure of the button can be simplified, thereby reducing processing costs of the button. Two guide grooves are disposed, so that structural strength of the button can be increased, thereby helping prolong a service life of the button.

In a possible design, the button is provided with a clamping portion. When the button moves relative to the tube, the clamping portion is capable of abutting against a top wall of the second accommodating cavity or a bottom wall of the second accommodating cavity.

In this application, when the button moves relative to the mounting base, the clamping portion is capable of abutting against the top wall or the bottom wall of the second accommodating cavity, to limit a movement distance of the button. This reduces a risk that the button is detached from the mounting base due to an excessively large movement distance, and improves stability of connection between the button and the mounting base.

In a possible design, the mounting base is further provided with a first through hole, and a part of the button extends out of the second accommodating cavity through the first through hole.

In this application, a part of the button extends out of the second accommodating cavity through the first through hole, so that the user drives the button to move, thereby facilitating a user operation.

In a possible design, the spring bar assembly is further provided with a second elastic piece. One end of the second elastic piece abuts against the button, the other end of the second elastic piece abuts against the mounting base. In the movement direction of the button, the second elastic piece is capable of driving the button to move away from the spring bar.

There is one or more second elastic pieces.

In this application, when the user cancels control on the button, the button can move upward in a second direction under driving of a rebound force of the second elastic piece, so that the button returns to an initial location. This facilitates a next operation of the user, simplifies the user operation, and improves user experience. There is one second elastic piece, so that a connection manner between the second elastic piece and the button is simplified, thereby simplifying a structural form of the button. There are a plurality of second elastic pieces, so that a size of the second elastic piece is reduced, thereby reducing a size of the mounting base.

In a possible design, the button is provided with a first mounting groove, and a part of the second elastic piece is located in the first mounting groove.

There is one or more first mounting grooves.

In this application, a part of the second elastic piece is located in the first mounting groove, so that a risk that connection between the second elastic piece and the button fails in a movement process of the button is reduced. This improves stability of connection between the button and the second elastic piece, and further improves working stability of the second elastic piece and the spring bar assembly.

In a possible design, the mounting base is provided with a first limiting portion, and the spring bar is provided with a limiting fitting portion. When the spring bar moves relative to the mounting base in the axial direction of the spring bar, the first limiting portion is capable of fitting with the limiting fitting portion.

In this application, when the spring bar moves toward the outside of the mounting base in a first direction, the first limiting portion is capable of abutting against the limiting fitting portion, to limit a movement distance of the spring bar. This reduces a risk that the spring bar is detached from a tube, and improves stability of connection between the spring bar and the tube.

In a possible design, the spring bar assembly further includes a tube. The tube is mounted on the mounting base, and at least a part of the tube is located in the first accommodating cavity.

The tube is provided with a third accommodating cavity. At least a part of the spring bar is located in the third accommodating cavity, and the spring bar is mounted on the mounting base by using the tube.

The button is located on the outside of the tube.

In this application, the spring bar is indirectly connected to the mounting base through the tube. In an assembly process of the spring bar assembly, assembly of the spring bar assembly is facilitated, and a production process of the spring bar assembly is simplified, thereby helping shorten a production period of the spring bar assembly.

In a possible design, the tube is provided with a second limiting portion, and the spring bar is provided with the limiting fitting portion. When the spring bar moves relative to the tube in an axial direction of the tube, the second limiting portion is capable of fitting with the limiting fitting portion.

In this application, the second limiting portion is capable of abutting against the limiting fitting portion, to limit a movement distance of the spring bar. This reduces a risk that the spring bar is detached from the tube and improves stability of connection between the spring bar and the tube.

In a possible design, the tube is provided with a second through hole, and a part of the lever extends out of the tube and extends into the guide groove through the second through hole.

In this application, one end of the lever extends out of the third accommodating cavity through the second through hole, so that the lever abuts against the first side walls. This simplifies structures of the tube, the lever, and the button.

In a possible design, the mounting base is of an integrated structure.

Alternatively, the mounting base includes an upper cover plate and a lower cover plate that are disposed separately, and the upper cover plate and the lower cover plate are fastened by using a connecting piece.

The upper cover plate or the lower cover plate is provided with the first accommodating cavity. Alternatively, the upper cover plate is provided with a second mounting groove, the lower cover plate is provided with a third mounting groove, and the second mounting groove and the third mounting groove enclose the first accommodating cavity.

In this application, the mounting base is integrally formed, so that mounting stability of a part inside the mounting base is improved. The mounting base includes the upper cover plate and the lower cover plate that are disposed separately, to facilitate mounting, maintenance, and replacement of the part inside the mounting base.

A second aspect of this application provides a watch strap. The watch strap includes a body and any one of the foregoing spring bar assemblies. The spring bar assembly is mounted on the body.

In this application, the spring bar assembly can facilitate mounting and dismounting of the watch strap, so that use performance of the watch strap and user experience are improved.

In a possible design, a preset distance exists between the mounting base and the body in a movement direction of the spring bar, or the mounting base abuts against the body.

In this application, there is a preset distance between the mounting base and the body, so that an overall size of the mounting base is reduced, and production costs of the mounting base are reduced. The mounting base abuts against the body, so that movement of the mounting base relative to the body in the first direction is limited, and stability of connection between the mounting base and the body is improved.

A third aspect of this application provides a watch. The watch includes a watch face and the watch strap. The watch strap is connected to the watch face through the spring bar assembly.

In this application, the spring bar assembly can facilitate mounting and dismounting of the watch strap and the watch face, so that use performance of the watch and user experience are improved.

It should be understood that the foregoing general descriptions and the following detailed descriptions are merely examples, and cannot limit this application.

### BRIEF DESCRIPTION OF THE DRAWINGS

FIG. 1 is a diagram of a structure of a watch strap in an embodiment according to this application;

FIG. 2 is a diagram of a structure of FIG. 1 from another angle;

FIG. 3 is a diagram of a structure of a spring bar assembly in FIG. 1 in an embodiment;

FIG. 4 is an enlarged view of a part I in FIG. 3;

FIG. 5 is a sectional view of the spring bar assembly in FIG. 3 when the spring bar assembly is in a locked state;

FIG. 6 is an exploded view of the spring bar assembly in FIG. 3 in an embodiment;

FIG. 7 is a diagram of a structure of connection between a lower cover plate and a body of a spring bar assembly in FIG. 1, where the lower cover plate and the body are integrally formed;

FIG. 8 is a diagram of a structure of a spring bar in FIG. 6 in an embodiment;

FIG. 9 is a diagram of a structure of a spring bar assembly in FIG. 1 in another embodiment;

FIG. 10 is an exploded view of FIG. 9;

FIG. 11 is a sectional view of the spring bar assembly in FIG. 10 when the spring bar assembly is in a locked state;

FIG. 12 is a sectional view of the spring bar assembly in FIG. 10 when the spring bar assembly is in an unlocked state;

FIG. 13 is a diagram of a structure of a telescopic assembly formed by a tube, a spring bar, a lever, and a first elastic piece in FIG. 10;

FIG. 14 is a diagram of a structure of connection between the telescopic assembly and a button in FIG. 13;

FIG. 15 is a diagram of a structure of connection between the telescopic assembly, the button, and a lower cover plate in FIG. 14;

FIG. 16 is a diagram of a structure of connection between the button and a second elastic piece in FIG. 14;

FIG. 17 is a sectional view of FIG. 13;

FIG. 18 is an exploded view of the spring bar assembly in FIG. 3 in another embodiment; and

FIG. 19 is a diagram of a structure of a spring bar and a lever in FIG. 18, where the spring bar and the lever are integrally formed.

The accompanying drawings are incorporated in this specification and constitute a part of this specification, show embodiments conforming to this application, and are used together with this specification to explain a principle of this application.

### DETAILED DESCRIPTION OF ILLUSTRATIVE EMBODIMENTS

To better understand technical solutions of this application, the following describes embodiments of this application in detail with reference to the accompanying drawings.

It should be noted that described embodiments are merely some rather than all of embodiments of this application. All other embodiments obtained by a person of ordinary skill in the art based on embodiments of this application without creative efforts shall fall within the protection scope of this application.

Terms used in embodiments of this application are merely intended to describe specific embodiments, but are not intended to limit this application. The terms “one”, “said” and “the” of singular forms used in embodiments and the appended claims of this application are also intended to include plural forms, unless otherwise specified in the context clearly.

It should be understood that the term “and/or” in this specification describes only an association relationship for describing associated objects and represents that three relationships may exist. For example, A and/or B may represent the following three cases: Only A exists, both A and B exist, and only B exists. In addition, the character “/” in this specification usually indicates an “or” relationship between the associated objects.

It should be noted that orientation words such as “above”, “below”, “left”, and “right” described in embodiments of this application are described from perspectives shown in the accompanying drawings, and should not be understood as a limitation on embodiments of this application. Moreover, in the context, it should be further understood that, when it is mentioned that one element is connected “above” or “below” another element, the element can be directly connected “above” or “below” the another element, or may be indirectly connected “above” or “below” the another element through an intermediate element.

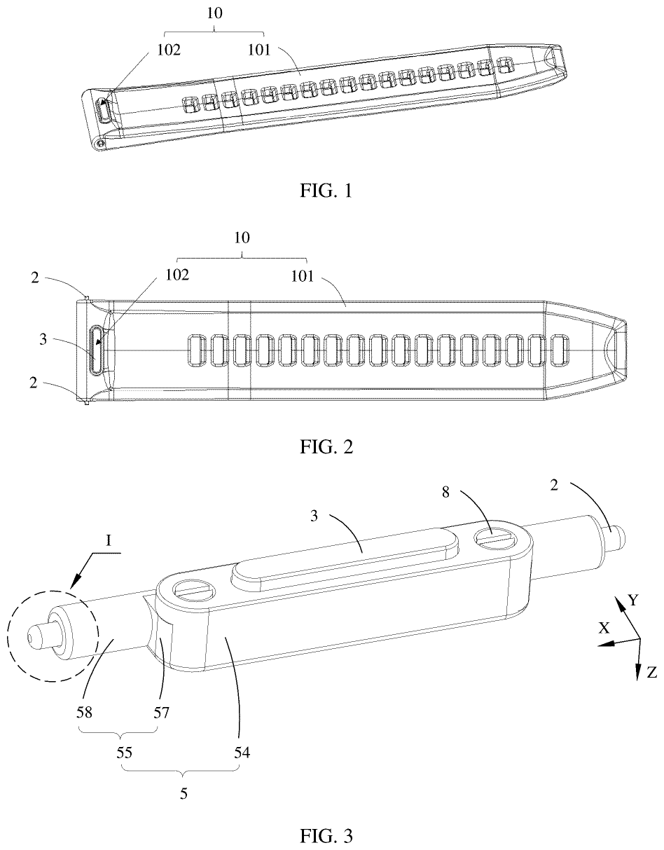

This application provides a watch. The watch includes a watch face and a watch strap 10. As shown in FIG. 1 and FIG. 2, the watch strap 10 includes a body 101 and a spring bar assembly 102. The spring bar assembly 102 is mounted on the body 101, and is configured to connect the watch strap 10 to the watch face. Usually, in a process of dismounting and mounting the watch strap 10 and the watch face, a dedicated tool needs to be used to cancel connection between the watch strap 10 and the watch face by the spring bar assembly 102. As a result, there is great difficulty in dismounting and mounting for a user. The watch strap 10 includes but is not limited to a braided watch strap, a leather watch strap, a metal watch strap, a ceramic watch strap, a rubber watch strap, and the like. In addition, the watch strap 10 may be a link watch strap. To be specific, the watch strap 10 includes a plurality of bodies 101 disposed in a length direction of the body 101. In this case, the spring bar assembly 102 may be further configured to connect to an adjacent body 101, to facilitate mounting and replacement of the body 101.

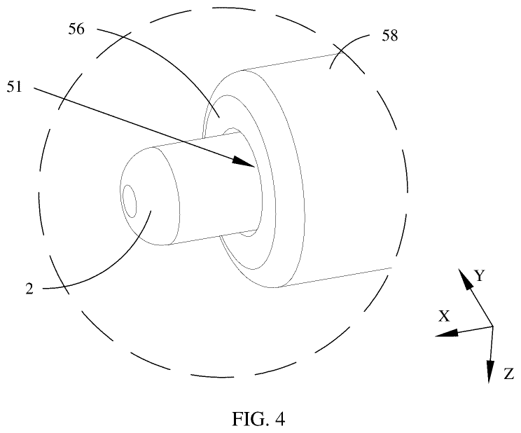

To resolve the foregoing problem, this application provides a spring bar assembly 102. As shown in FIG. 3 to FIG. 6, the spring bar assembly 102 includes a mounting base 5, a spring bar 2, a button 3, and a lever 4. The mounting base 5 is provided with a first accommodating cavity 51, at least a part of the spring bar 2 is located in the first accommodating cavity 51, and the spring bar 2 can move relative to the mounting base 5 in an axial direction of the spring bar 2, so that a part of the spring bar 2 extends out of or retracts into the first accommodating cavity 51, to enable the spring bar assembly 102 to be in a locked or unlocked state. One end of the lever 4 is connected to the spring bar 2, and the other end is connected to the button 3, and the button 3 can move relative to the mounting base 5 in a radial direction of the spring bar 2. In a movement process of the button 3, the button 3 can drive the lever 4 to move in the axial direction of the spring bar 2, and further drive the spring bar 2 to move, so that a part of the spring bar 2 extends out of or retracts into a third accommodating cavity 11. The spring bar assembly 102 is provided with a first direction X, a second direction Z, and a third direction Y that are perpendicular to each other. The first direction X is the axial direction of the spring bar 2, namely, a movement direction of the spring bar 2. The second direction Z is a radial direction of the spring bar 2 in a vertical plane, namely, a movement direction of the button 3. The third direction Y is a radial direction of the spring bar 2 in a horizontal plane.

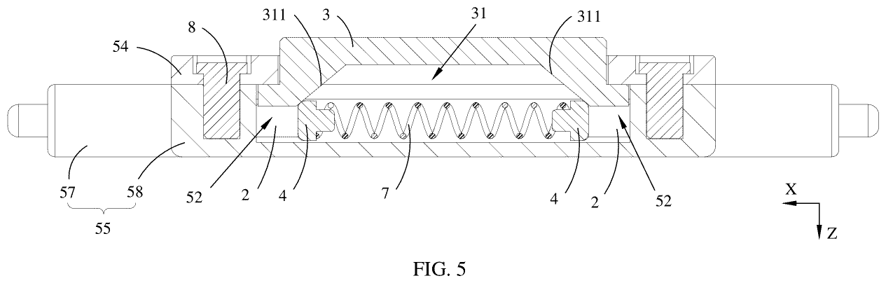

In this embodiment, as shown in FIG. 5, when the spring bar assembly 102 is in a locked state, a part of the spring bar 2 extends out of the first accommodating cavity 51 and is clamped to an adjacent watch strap 10 or a watch face, to implement connection between adjacent bodies 101 and between the watch strap 10 and the watch face. When a user drives the button 3 to move downward in the second direction Z, the lever 4 is driven by the button 3 to move in the first direction X, and drives the spring bar 2 to move in the first direction X. In this way, the spring bar 2 retracts into the first accommodating cavity 51, and the spring bar assembly 102 is switched to an unlocked state, so that the user can dismount and mount the watch strap 10 and the watch face conveniently. Therefore, in a process of dismounting and mounting the watch strap 10 and the watch face, the user presses the button 3 to implement movement of the spring bar 2, so that the spring bar assembly 102 switches between the locked state and the unlocked state. This simplifies an operation of dismounting and mounting the watch strap 10 and the watch face by the user, reduces dismounting and mounting difficulty for the user, and improves user experience.

The spring bar assembly 102 further includes a first elastic piece 7 disposed inside the mounting base 5. The first elastic piece 7 is connected to the spring bar 2 or the lever 4. In a process in which the spring bar assembly 102 switches from the locked state to the unlocked state, the first elastic piece 7 is compressed and generates a rebound force. When the user cancels limitation on the button 3, the spring bar 2 and the lever 4 are driven by the rebound force generated by the first elastic piece 7 to move toward the outside of the mounting base 5 in the first direction X, so that the spring bar assembly 102 automatically switches to the locked state, and an operation of the user is simplified.

Specifically, in an embodiment, there is one spring bar 2 and one lever 4. One end of the first elastic piece 7 is connected to the spring bar 2 or the lever 4, and the other end is connected to the mounting base 5, to simplify a structure of the spring bar assembly 102, reduce production costs of the spring bar assembly 102, and help reduce an overall size of the spring bar assembly 102.

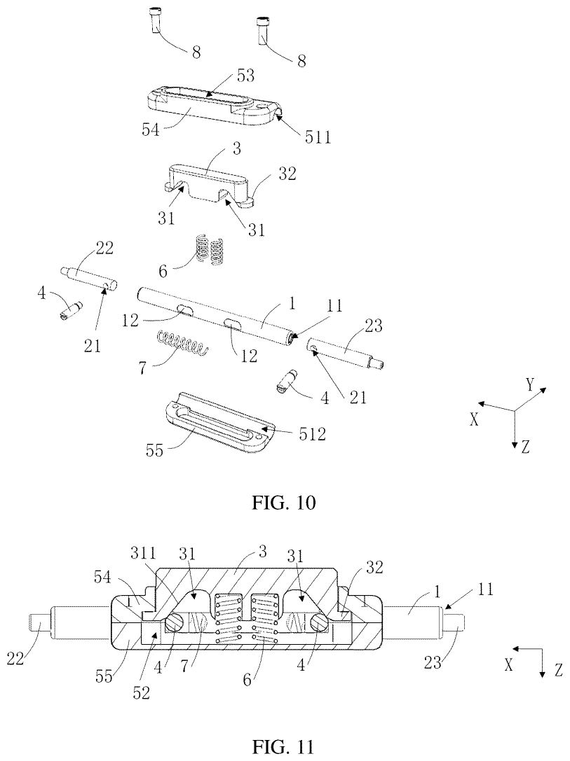

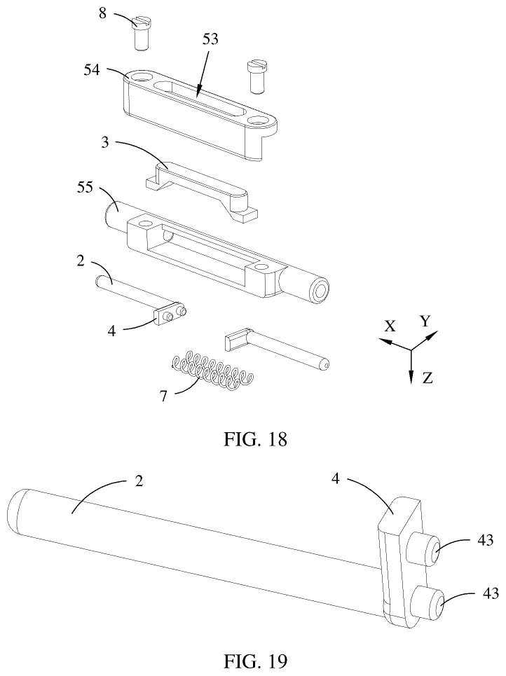

In another embodiment, as shown in FIG. 10, the spring bar 2 at least includes a first spring bar 22 and a second spring bar 23 that are disposed opposite to each other in the first direction X. The button 3 can drive the first spring bar 22 to move, and/or the button 3 can drive the second spring bar 23 to move. As shown in FIG. 10 and FIG. 18, the lever 4 includes a first lever 41 connected to the first spring bar 22 and a second lever 42 connected to the second spring bar 23. Specifically, as shown in FIG. 17 and FIG. 18, the first spring bar 22 and the second spring bar 23 are connected through the first elastic piece 7. In other words, as shown in FIG. 17, two ends of the first elastic piece 7 respectively abut against the first spring bar 22 and the second spring bar 23. Alternatively, as shown in FIG. 18, the first lever 41 and the second lever 42 are connected through the first elastic piece 7. In other words, two ends of the first elastic piece 7 respectively abut against the first lever 41 and the second lever 42 to improve flexibility of a mounting location of the first elastic piece 7.

In this embodiment, when the user drives the button 3 to move downward in the second direction Z, the first spring bar 22 and/or the second spring bar 23 are/is driven by the button 3 to move toward the inside of the mounting base 5 in the first direction X, so that the first spring bar 22 and/or the second spring bar 23 retract/retracts into the inside of the first accommodating cavity 51. In this case, the first elastic piece 7 is compressed and generates a rebound force under the action of the first spring bar 22 and the second spring bar 23. When the user cancels the limitation on the button 3, the first spring bar 22 and/or the second spring bar 23 are/is driven by the rebound force generated by the first elastic piece 7 to move toward the outside of the mounting base 5 in the first direction X, so that the first spring bar 22 and/or the second spring bar 23 extend/extends out of the first accommodating cavity 51, and the spring bar assembly 102 automatically switches to the locked state.

In an embodiment, the first elastic piece 7 is directly clamped and fastened by the spring bar 2 or the lever 4, to simplify structures of the spring bar 2 and the lever 4. In another embodiment, as shown in FIG. 19, the spring bar 2 or the lever 4 is provided with a mounting portion 43, and the first elastic piece 7 is tubed on the mounting portion 43, to improve stability of connection between the first elastic piece 7 and the spring bar 2 and connection between the first elastic piece 7 and the lever 4.

There is one or more first elastic pieces 7, so that flexibility of a size and a type of the first elastic piece 7 that can be selected is improved. A specific quantity of first elastic pieces 7 is not specially limited in this embodiment of this application.

In addition, in this embodiment, the button 3 can independently drive the first spring bar 22 or the second spring bar 23 to move, so that the spring bar assembly 102 is in a single-side unlocked state, and the button 3 can simultaneously drive the first spring bar 22 and the second spring bar 23 to move, to enable the spring bar assembly 102 to be in a double-side unlocked state. This improves diversity of unlocked states of the spring bar assembly 102. When the first spring bar 22 or the second spring bar 23 is damaged and cannot move in the first direction X or is insensitive to movement, the user may separately drive, by using the button 3, the second spring bar 23 or the first spring bar 22 on the other side to move, so that a risk that the spring bar assembly 102 cannot switch to the double-side unlocked state due to that the single-side spring bar 2 is insensitive to movement is reduced, thereby improving working stability of the spring bar assembly 102, and improving a service life of the spring bar assembly 102. When the spring bar assembly 102 is in the single-side unlocked state, for example, the first spring bar 22 is in the unlocked state, and the second spring bar 23 is in the locked state, to separate the adjacent bodies 101, the watch strap 10, and the watch face, the watch strap 10 or the watch face needs to be controlled to tilt, so that the second spring bar 23 is separated from the adjacent watch strap 10 or the watch face. To avoid interference when the watch strap 10 or the watch face rolls, gaps between adjacent bodies 101 and between the watch strap 10 and the watch face need to be increased, to facilitate dismounting and mounting of the watch strap 10 and the watch face. This reduces processing precision of the watch strap 10 and the watch face, and reduces production costs of the watch strap 10 and the watch face. When the spring bar assembly 102 is in the double-side unlocked state, separation between adjacent bodies 101 and between the watch strap 10 and the watch face can be implemented without tilting the watch strap 10 and the watch face, so that gaps between the adjacent bodies 101 and between the watch strap 10 and the watch face are small. In this way, a risk that the spring bar assembly 102 is damaged or automatically switches to the unlocked state under an action of an external object is reduced, thereby improving working stability of the spring bar assembly 102 and prolonging a service life of the spring bar assembly 102.

Specifically, the first spring bar 22 and the first lever 41 are disposed separately or are integrally formed, and the second spring bar 23 and the second lever 42 are disposed separately or are integrally formed, to improve flexibility of structures of the spring bar 2 and the lever 4. As shown in FIG. 10, the spring bar 2 and the lever 4 are disposed separately. When the spring bar 2 and the lever 4 are damaged, the spring bar 2 and the lever 4 can be easily replaced, thereby prolonging an overall service life of the spring bar assembly 102. In addition, sizes of the spring bar 2 and the lever 4 can be easily adjusted, so that the spring bar assembly 102 is applicable to watch straps 10 of different sizes, and an application scope of the spring bar assembly 102 can be expanded. As shown in FIG. 18 and FIG. 19, the spring bar 2 and the lever 4 are integrally formed, so that stability of connection between the spring bar 2 and the lever 4 can be improved, and a risk that the spring bar 2 is separated from the lever 4 in a process of mounting, transporting, and using the spring bar assembly 102 is reduced, thereby improving working stability of the spring bar assembly 102.

When the spring bar 2 and the lever 4 are disposed separately, as shown in FIG. 17, the spring bar 2 is provided with a fitting portion 21, and one end of the lever 4 is fastened to the fitting portion 21. In this embodiment, a manner of connecting the lever 4 to the fitting portion 21 includes but is not limited to threaded connection, welding, and bonding. In this embodiment, the lever 4 is connected to the fitting portion 21 in a threaded manner, to simplify structures of the lever 4 and the fitting portion 21.

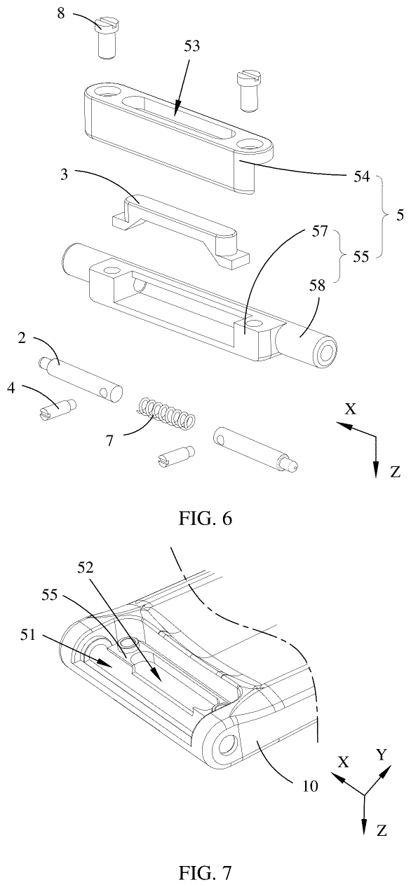

As shown in FIG. 5 and FIG. 6, the mounting base 5 is further provided with a second accommodating cavity 52 and a first through hole 53. The second accommodating cavity 52 and the first accommodating cavity 51 are disposed at an interval in the third direction Y. The button 3 is mounted in the second accommodating cavity 52, and a part of the button 3 extends out of the second accommodating cavity 52 through the first through hole 53, so that the user drives the button 3 to move in the second direction Z, thereby facilitating a user operation.

The first accommodating cavity 51 communicates with the second accommodating cavity 52, to facilitate connection between the spring bar 2, the lever 4, and the button 3.

In an embodiment, when the spring bar assembly 102 is connected to the body 101, the mounting base 5 abuts against the body 101 in the first direction X. Specifically, as shown in FIG. 3, the mounting base 5 includes a body portion 57, a part of the body portion 57 extends outward in the first direction X to form an extension portion 58, and the first accommodating cavity 51 passes through the body portion 57 and the extension portion 58. When the spring bar assembly 102 is in the unlocked state, the spring bar 2 can completely retract into the mounting base 5. When the spring bar 2 moves in the first direction X, a first limiting portion 56 of the mounting base 5 can abut against two ends of a tube 1 in the first direction X, to limit movement of the tube 1 relative to the mounting base 5 in the first direction X, so that stability of connection between the tube 1 and the mounting base 5 is improved.

In this embodiment, the mounting base 5 can abut against the body 101, to limit movement of the mounting base 5 relative to the body 101 in the first direction X, so that stability of connection between the mounting base 5 and the watch strap 10 is improved.

In another embodiment, as shown in FIG. 9, when the spring bar assembly 102 is connected to the body 101, there is a preset distance between the mounting base 5 and the body 101 in the first direction X. In other words, when the spring bar assembly 102 is in the unlocked state, a part of the spring bar 2 is located outside the mounting base 5.

In this embodiment, there is a preset distance between the mounting base 5 and the body 101, so that an overall size of the mounting base 5 and production costs of the mounting base 5 are reduced.

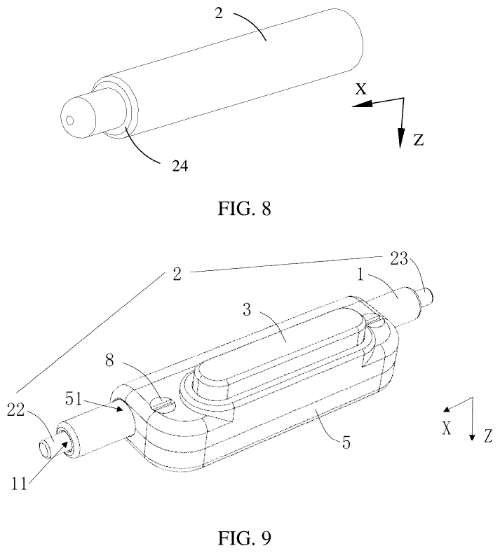

In an embodiment, as shown in FIG. 3, FIG. 5, and FIG. 6, the spring bar 2 is directly connected to the mounting base 5. To be specific, the spring bar 2 is directly mounted in the first accommodating cavity 51. As shown in FIG. 4, the mounting base 5 is provided with a first limiting portion 56, and as shown in FIG. 8, the spring bar 2 is provided with a limiting fitting portion 24. When the spring bar 2 moves in the first direction X toward the outside of the mounting base 5, the first limiting portion 56 can abut against the limiting fitting portion 24, to limit a movement distance of the spring bar 2, so that a risk that the spring bar 2 is detached from the tube 1 is reduced, and stability of connection between the spring bar 2 and the tube 1 is improved.

In this embodiment, the spring bar 2 is directly connected to the mounting base 5. In this way, structures of the spring bar 2 and the mounting base 5 are simplified, and a quantity of parts required for connecting the spring bar 2 to the mounting base 5 is reduced, thereby helping reduce an overall size of the spring bar assembly 102. Processing costs of the spring bar assembly 102 are reduced, and space of the watch strap 10 occupied for mounting the spring bar assembly 102 is reduced, thereby expanding an application scope of the spring bar assembly 102, and helping improve user experience.

In another embodiment, as shown in FIG. 9 to FIG. 12, the spring bar assembly 102 further includes a tube 1, and the spring bar 2 is indirectly connected to the mounting base 5 through the tube 1. To be specific, at least a part of the tube 1 is located in the first accommodating cavity 51 and abuts against a side wall of the first accommodating cavity 51. The tube 1 is hollow to form a third accommodating cavity 11, and at least a part of the spring bar 2 is located in the third accommodating cavity 11. In addition, the spring bar 2 can move relative to the tube 1 in an axial direction of the tube 1, so that a part of the spring bar 2 extends out of or retracts into the third accommodating cavity 11.

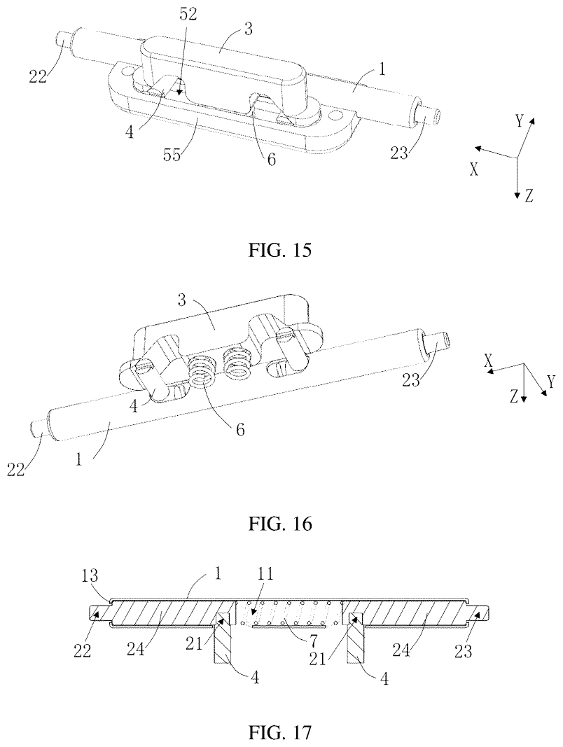

In this embodiment, the spring bar 2 is indirectly connected to the mounting base 5 through the tube 1. In an assembly process of the spring bar assembly 102, as shown in FIG. 13, FIG. 14, and FIG. 15, the tube 1, the spring bar 2, and the lever 4 may be first assembled into a telescopic assembly, and then the telescopic assembly and the button 3 are mounted on the mounting base 5, to facilitate assembly of the spring bar assembly 102. In addition, the telescopic assembly can be directly purchased, thereby simplifying a production process of the spring bar assembly 102, and helping shorten a production cycle of the spring bar assembly 102.

As shown in FIG. 14 and FIG. 15, the button 3 is located on an outer side of the tube 1. If the button 3 is directly mounted on the tube 1, to improve mounting stability of the button 3, a size of the tube 1 needs to be increased, and a connection structure between the button 3 and the tube 1 is complex. Therefore, in this embodiment, the tube 1 and the button 3 are separately connected to the mounting base 5, and the button 3 is mounted on an outer side of the tube 1, so that the structures of the tube 1 and the button 3 are simplified while the connection stability between the button 3 and the tube 1 is ensured, thereby reducing production costs of the tube 1 and the button 3.

The button 3 is mounted on the outer side of the tube 1. Therefore, as shown in FIG. 13 and FIG. 17, the tube 1 is provided with a second through hole 12, and one end of the lever 4 extends out of the third accommodating cavity 11 through the second through hole 12, so that the lever 4 abuts against first side walls 311, and structures of the tube 1, the lever 4, and the button 3 are simplified.

As shown in FIG. 17, the tube 1 is provided with a second limiting portion 13. When the spring bar 2 moves toward the outside of the tube 1 in the first direction X, the second limiting portion 13 can abut against the limiting fitting portion 24, to limit a movement distance of the spring bar 2, so that a risk that the spring bar 2 is detached from the tube 1 is reduced, thereby improving stability of connection between the spring bar 2 and the tube 1.

Specifically, as shown in FIG. 5 and FIG. 14, the button 3 is provided with a guide groove 31, and in the first direction X, the guide groove 31 includes first side walls 311 that are disposed in an oblique manner. To be specific, there is a preset included angle between an extension direction of the first side walls 311 and the second direction Z. One end of the lever 4 abuts against the first side walls 311, and the other end is fastened to the spring bar 2.

In this embodiment, when the user drives the button 3 to move downward in the second direction Z, the lever 4 is driven by the first side walls 311 to drive the first spring bar 22 and/or the second spring bar 23 to move toward the inside of the mounting base 5 in the first direction X. The guide groove 31 is disposed, so that a quantity of parts required for the button 3 to drive the spring bar 2 to move is reduced, thereby simplifying structures of the button 3, the lever 4, and the spring bar 2, and further reducing production costs of the spring bar assembly 102. The first side walls 311 are disposed in an oblique manner, so that a structure of the guide groove 31 is simplified, thereby reducing production costs of the button 3.

Specifically, in an embodiment, as shown in FIG. 5, there is one guide groove 31, the first side walls 311 are disposed opposite to each other in the first direction X, and the first lever 41 and the second lever 42 respectively abut against the first side walls 311 on the two sides. A guide groove 31 is disposed, so that a structure of the button 3 can be simplified, thereby reducing processing costs of the button.

In another embodiment, as shown in FIG. 14, there are two guide grooves 31, and the guide grooves 31 are disposed at an interval in the first direction X. The guide groove 31 includes a first side wall 311 and a second side wall 312 that are disposed opposite to each other in the first direction. An extension direction of the second side wall 312 is parallel to an extension direction of the first side wall 311, or there is a preset included angle between an extension direction of the second side wall 312 and an extension direction of the first side wall 311. The extension direction of the second side wall 312 is not specially limited in this application. In this embodiment, the extension direction of the second side wall 312 is parallel to the second direction Z, to facilitate processing of the guide groove 31. The two guide grooves 31 are disposed, so that structural strength of the button 3 can be increased, thereby helping prolong a service life of the button 3.

In a process in which the spring bar assembly 102 automatically switches from the unlocked state to the locked state, in an embodiment, as shown in FIG. 5, the button 3 moves upward in the second direction Z under the action of the first elastic piece 7, the spring bar 2, the lever 4, and the guide groove 31, so that the button 3 returns to an initial location. This facilitates a next operation of the user, simplifies the user operation, and improves user experience.

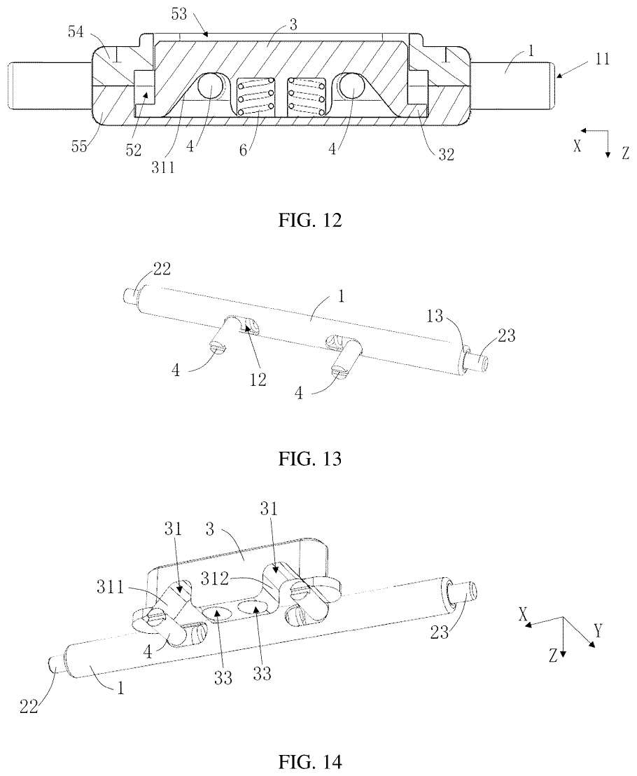

In another embodiment, as shown in FIG. 11 and FIG. 12, the spring bar assembly 102 is provided with a second elastic piece 6, one end of the second elastic piece 6 abuts against the button 3, and the other end abuts against a bottom wall of the second accommodating cavity 52. When the user drives the button 3 to move downward in the second direction Z, the second elastic piece 6 is compressed and generates a rebound force. When the user cancels control on the button 3, the button 3 can be driven by the rebound force of the second elastic piece 6 to move upward in the second direction Z, so that the button 3 returns to an initial location. This facilitates a next operation of the user, simplifies the user operation, and improves user experience.

There is one or more second elastic pieces 6. To ensure that the button 3 can accurately return to the initial location, the rebound force generated by the second elastic piece 6 needs to reach a preset value. If there is one second elastic piece 6, a second elastic piece 6 with a large size needs to be selected. Consequently, space required for mounting the second elastic piece 6 is large, and a size of the mounting base 5 is large. Therefore, in this embodiment, as shown in FIG. 11 and FIG. 12, there are a plurality of second elastic pieces 6, so that the size of the second elastic piece 6 is reduced, thereby reducing a size of the mounting base 5. The plurality of second elastic pieces 6 are evenly distributed on two sides and/or a middle part of the button 3, so that the button 3 is evenly subject to a force. This reduces a risk of damage caused by excessive force on a part of the button 3, and prolongs a service life of the button 3. In this embodiment, as shown in FIG. 11 and FIG. 12, the plurality of second elastic pieces 6 are evenly distributed in the middle of the button 3, to further reduce sizes of the button 3 and the mounting base 5. Preferably, there are two second elastic pieces 6, and the quantity of the second elastic pieces 6 is reduced while it is ensured that the second elastic pieces 6 work stably, to reduce space required for mounting the second elastic pieces 6.

In addition, as shown in FIG. 14 and FIG. 16, the button 3 is provided with a first mounting groove 33, and a part of the second elastic piece 6 is located in the first mounting groove 33, so that a risk that connection between the second elastic piece 6 and the button 3 fails in a movement process of the button 3 is reduced. This improves stability of connection between the button 3 and the second elastic piece 6, and further improves working stability of the second elastic piece 6 and the spring bar assembly 102.

When there are a plurality of second elastic pieces 6, there may be one or more first mounting grooves 33. When there is one first mounting groove 33, a risk that a distance between adjacent first mounting grooves 33 is excessively small is reduced, thereby improving strength of the first mounting groove 33. When there are a plurality of first mounting grooves 33, a risk of mutual interference between second elastic pieces 6 caused by mounting of plurality of second elastic pieces 6 in one first mounting groove 33 is reduced, thereby improving working stability of the second elastic piece 6. The quantity of the first mounting grooves 33 is not specially limited in this application. In this embodiment, the first mounting grooves 33 are in a one-to-one correspondence with the second elastic pieces 6.

As shown in FIG. 11 and FIG. 12, the button 3 is provided with a clamping portion 32. When the button 3 moves relative to the mounting base 5 in the second direction Z, the clamping portion 32 can abut against the top wall or the bottom wall of the second accommodating cavity 52, to limit a movement distance of the button 3. This reduces a risk that the button 3 is detached from the mounting base 5 due to an excessively large movement distance, and improves stability of connection between the button 3 and the mounting base 5.

Specifically, in an embodiment, the mounting base 5 is integrally formed, to increase mounting stability of internal parts of the mounting base 5.

In another embodiment, as shown in FIG. 5 and FIG. 6, the mounting base 5 includes an upper cover plate 54 and a lower cover plate 55 that are disposed separately, to facilitate mounting, maintenance, and replacement of the internal parts of the mounting base 5. A connection manner between the upper cover plate 54 and the lower cover plate 55 includes but is not limited to bonding, welding, clamping, and fastening by using a connecting piece 8. As shown in FIG. 6, the upper cover plate 54 and the lower cover plate 55 are fastened by using the connecting piece 8. The connecting piece 8 includes but is not limited to a screw, a bolt, and a rivet.

When the mounting base 5 is connected to the body 101, in an embodiment, as shown in FIG. 1 and FIG. 2, the mounting base 5 and the body 101 are disposed separately. In other words, the mounting base 5 is detachably connected to the body 101 as a whole, and the body 101 may be connected to the spring bar assembly 102 by wrapping the mounting base 5 by the body 101. In another embodiment, as shown in FIG. 7, the lower cover plate 55 and the body 101 are integrally formed. In a process of mounting the spring bar assembly 102, structures inside the mounting base 5 such as the spring bar 2, the lever 4, and the button 3 are first mounted on the lower cover plate 55, then the upper cover plate 54 is closed, and the upper cover plate 54 and the lower cover plate 55 are fastened by using the connecting piece 8, to implement connection between the body 101 and the spring bar assembly 102.

The upper cover plate 54 and the lower cover plate 55 enclose the first accommodating cavity 51. In an embodiment, as shown in FIG. 6 and FIG. 7, the upper cover plate 54 or the lower cover plate 55 is provided with the first accommodating cavity 51, to simplify a processing process of the upper cover plate 54 and the lower cover plate 55, and reduce processing costs of the upper cover plate 54 and the lower cover plate 55. In another embodiment, as shown in FIG. 9 and FIG. 10, the upper cover plate 54 is provided with a second mounting groove 511, the lower cover plate 55 is provided with a third mounting groove 512, and the second mounting groove 511 and the third mounting groove 512 enclose the first accommodating cavity 51, to increase structural strength of the upper cover plate 54 and the lower cover plate 55, and prolong a service life of the upper cover plate 54 and the lower cover plate 55.

It should be noted that a part of this patent application document includes copyright-protected content. The copyright owner reserves the copyright except copies made for the patent documents or the recorded content of the patent documents in the China National Intellectual Property Administration.

What is claimed is:

1. A spring bar assembly, wherein the spring bar assembly comprises:
a mounting base, and a spring bar and a button that are mounted on the mounting base, wherein the mounting base comprises a first accommodating cavity and a second accommodating cavity that are distributed in a radial direction of the spring bar, at least a part of the spring bar is located in the first accommodating cavity, at least a part of the button is located in the second accommodating cavity, the button is movable relative to the mounting base, a movement direction of the button is perpendicular to an axial direction of the spring bar, the movement direction of the button is perpendicular to a distribution direction of the first accommodating cavity and the second accommodating cavity, and the button is provided with a guide groove;
a lever, wherein a first end of the lever extends into the guide groove and abuts against first side walls of the guide groove, and a second end of the lever is connected to the spring bar; and
a first elastic piece, wherein the first elastic piece is disposed in the mounting base, and the first elastic piece is connected to the spring bar or the lever;
wherein when the button moves towards the spring bar in the axial direction of the spring bar, the lever is capable of driving the spring bar to move toward the inside of the mounting base and compress the first elastic piece;
wherein in the axial direction of the spring bar, the first elastic piece is capable of driving the lever and the spring bar to move towards the outside of the mounting base; and
wherein there is one guide groove, and the first side walls are disposed opposite to each other in the axial direction of the spring bar, or there are two guide grooves, the two guide grooves are distributed in the axial direction of the spring bar, and in the axial direction of the spring bar, the two guide grooves comprise second side walls that are disposed opposite to the first side walls, and there is a preset included angle between an extension direction of the second side wall and the extension direction of the first side wall.

2. The spring bar assembly according to claim 1, wherein:
in the axial direction of the spring bar, the spring bar comprises a first spring bar and a second spring bar that are disposed opposite to each other;
the lever comprises a first lever and a second lever, the first lever is connected to the first spring bar, and the second lever is connected to the second spring bar; or the first lever and the first spring bar are integrally formed, and the second lever and the second spring bar are integrally formed; and
the button is capable of driving the first spring bar or the second spring bar to move.

3. The spring bar assembly according to claim 2, wherein:
a first end of the first elastic piece abuts against the first spring bar, and a second end of the first elastic piece abuts against the second spring bar; or
a first end of the first elastic piece abuts against the first lever, and a second end of the first elastic piece abuts against the second lever.

4. The spring bar assembly according to claim 1, wherein:
the first elastic piece is clamped and fastened by the spring bar or the lever; or
the spring bar or the lever is provided with a mounting portion, and the first elastic piece is tubed on the mounting portion.

5. The spring bar assembly according to claim 1, further comprising a second elastic piece disposed in the mounting base, wherein the second elastic piece is connected to the spring bar or the lever;
wherein when the button moves towards the spring bar in the axial direction of the spring bar, the lever is capable of driving the spring bar to move toward the inside of the mounting base and compress the second elastic piece; and
wherein in the axial direction of the spring bar, the second elastic piece is capable of driving the lever and the spring bar to move towards the outside of the mounting base.

6. The spring bar assembly according to claim 1, wherein in the movement direction of the button, there is a preset included angle between an extension direction of the first side wall and the movement direction of the button.

7. The spring bar assembly according to claim 1, wherein the button is provided with a clamping portion, and when the button moves relative to the mounting base, the clamping portion is capable of abutting against a top wall of the second accommodating cavity or a bottom wall of the second accommodating cavity.

8. The spring bar assembly according to claim 1, wherein the mounting base is further provided with a first through hole, and a part of the button extends out of the second accommodating cavity through the first through hole.

9. The spring bar assembly according to claim 1, wherein the spring bar assembly is further provided with a third elastic piece, a first end of the third elastic piece abuts against the button, a second end of the third elastic piece abuts against the mounting base, and in the movement direction of the button, the third elastic piece is capable of driving the button to move away from the spring bar.

10. The spring bar assembly according to claim 9, wherein:
the button is provided with a first mounting groove, and a part of the third elastic piece is located in the first mounting groove.

11. The spring bar assembly according to claim 1, wherein the mounting base is provided with a first limiting portion, the spring bar is provided with a limiting fitting portion, and when the spring bar moves relative to the mounting base in the axial direction of the spring bar, the first limiting portion is capable of fitting with the limiting fitting portion.

12. The spring bar assembly according to claim 1, wherein:
the spring bar assembly further comprises a tube, the tube is mounted on the mounting base, and at least a part of the tube is located in the first accommodating cavity;
the tube is provided with a third accommodating cavity, at least a part of the spring bar is located in the third accommodating cavity, and the spring bar is mounted on the mounting base by using the tube; and
the button is located on the outside of the tube.

13. The spring bar assembly according to claim 12, wherein the tube is provided with a second limiting portion, the spring bar is provided with a limiting fitting portion, and when the spring bar moves relative to the tube in an axial direction of the tube, the second limiting portion is capable of fitting with the limiting fitting portion.

14. The spring bar assembly according to claim 12, wherein the tube is provided with a second through hole, and a part of the lever extends out of the tube and extends into the guide groove through the second through hole.

15. The spring bar assembly according to claim 1, wherein:
the mounting base is of an integrated structure; or
the mounting base comprises an upper cover plate and a lower cover plate that are disposed separately, and the upper cover plate and the lower cover plate are fastened by using a connecting piece, the upper cover plate or the lower cover plate is provided with the first accommodating cavity, or the upper cover plate is provided with a second mounting groove, the lower cover plate is provided with a third mounting groove, and the second mounting groove and the third mounting groove enclose the first accommodating cavity.

16. A watch strap, wherein the watch strap comprises:
a body; and
a spring bar assembly, wherein the spring bar assembly comprises:
a mounting base, and a spring bar and a button that are mounted on the mounting base, wherein the mounting base comprises a first accommodating cavity and a second accommodating cavity that are distributed in a radial direction of the spring bar, at least a part of the spring bar is located in the first accommodating cavity, at least a part of the button is located in the second accommodating cavity, the button is moveable relative to the mounting base, a movement direction of the button is perpendicular to an axial direction of the spring bar, the movement direction of the button is perpendicular to a distribution direction of the first accommodating cavity and the second accommodating cavity, and the button is provided with a guide groove;
a lever, wherein a first end of the lever extends into the guide groove and abuts against first side walls of the guide groove, and a second end of the lever is connected to the spring bar; and
a first elastic piece, the first elastic piece is disposed in the mounting base, and the first elastic piece is connected to the spring bar or the lever;
wherein when the button moves towards the spring bar, in the axial direction of the spring bar, the lever is capable of driving the spring bar to move toward the inside of the mounting base and compress the first elastic piece;
wherein in the axial direction of the spring bar, the first elastic piece is capable of driving the lever and the spring bar to move towards the outside of the mounting base;
wherein there is one guide groove, and the first side walls are disposed opposite to each other in the axial direction of the spring bar; or there are two guide grooves, the two guide grooves are distributed in the axial direction of the spring bar, and in the axial direction of the spring bar, the two guide grooves comprise second side walls that are disposed opposite to the first side walls, and there is a preset included angle between an extension direction of the second side wall and the extension direction of the first side wall; and
wherein the spring bar assembly is mounted on the body.

17. The watch strap according to claim 16, wherein a preset distance exists between the mounting base and the body in a movement direction of the spring bar, or the mounting base abuts against the body.

18. The watch strap according to claim 16, wherein:
in the axial direction of the spring bar, the spring bar comprises at least a first spring bar and a second spring bar that are disposed opposite to each other;
the lever comprises a first lever and a second lever, the first lever is connected to the first spring bar, and the second lever is connected to the second spring bar; or the first lever and the first spring bar are integrally formed, and the second lever and the second spring bar are integrally formed; and
the button is capable of driving the first spring bar or the second spring bar to move.

19. A watch, wherein the watch comprises:
a watch face; and
a watch strap, comprising:
a body; and
a spring bar assembly, wherein the spring bar assembly comprises:
a mounting base, and a spring bar and a button that are mounted on the mounting base, wherein the mounting base comprises a first accommodating cavity and a second accommodating cavity that are distributed in a radial direction of the spring bar, at least a part of the spring bar is located in the first accommodating cavity, at least a part of the button is located in the second accommodating cavity, the button is moveable relative to the mounting base, a movement direction of the button is perpendicular to an axial direction of the spring bar, the movement direction of the button is perpendicular to a distribution direction of the first accommodating cavity and the second accommodating cavity, and the button is provided with a guide groove;
a lever, wherein a first end of the lever extends into the guide groove and abuts against first side walls of the guide groove, and a second end of the lever is connected to the spring bar; and
a first elastic piece, the first elastic piece is disposed in the mounting base, and the first elastic piece is connected to the spring bar or the lever;
wherein when the button moves towards the spring bar, in the axial direction of the spring bar, the lever is capable of driving the spring bar to move toward the inside of the mounting base and compress the first elastic piece;
wherein in the axial direction of the spring bar, the first elastic piece is capable of driving the lever and the spring bar to move towards the outside of the mounting base;
wherein there is one guide groove, and the first side walls are disposed opposite to each other in the axial direction of the spring bar; or there are two guide grooves, the two guide grooves are distributed in the axial direction of the spring bar, and in the axial direction of the spring bar, the two guide grooves comprise second side walls that are disposed opposite to the first side walls, and there is a preset included angle between an extension direction of the second side wall and the extension direction of the first side wall;
wherein the spring bar assembly is mounted on the body; and
wherein the watch strap is connected to the watch face through the spring bar assembly.

20. The watch according to claim 19, wherein a preset distance exists between the mounting base and the body in a movement direction of the spring bar, or the mounting base abuts against the body.
